(19) United States
(12) Patent Application Publication
(10) Pub. No.: US 2016/0138794 A1
(43) Pub. Date: May 19, 2016

(54) Wearable Safety Light Array

(71) Applicant: Paul Alfred Engelberth, Suwanee, GA (US)

(72) Inventor: Paul Alfred Engelberth, Suwanee, GA (US)

(21) Appl. No.: 14/847,623

(22) Filed: Sep. 8, 2015

Related U.S. Application Data
(60) Provisional application No. 62/065,784, filed on Nov. 14, 2014.

(51) Int. Cl. F21V 33/00; F21V 23/04; F21L 4/02

(52) U.S. Cl. CPC F21V 33/0076; F21L 4/02; F21V 23/0414; F21Y 2101/02

(57) ABSTRACT

A wearable safety light array for personal safety. The invention is configured to be worn by an individual when there is a need for enhanced visibility by other persons and/or sensors and when the person needs enhanced visibility of their surroundings due to low-light or no-light situations. The invention uses a high density energy storage device and specially enclosed light sources to provide the wearer with a safer operating environment.

### CROSS REFERENCE TO RELATED APPLICATIONS

Not Applicable

STATEMENT OF FEDERALLY SPONSORED RESEARCH/DEVELOPMENT

Not Applicable

### BACKGROUND OF THE INVENTION

1. Field of the Invention

This invention relates to the field of wearable personal safety equipment. The invention is made up of elements that provide enhanced visibility to other people and visual sensors plus enhancing the ability of the wearer to see in low light or no-light environments.

2. Description of the Related Art

There are many known devices that rely on reflective materials or lights to enhance the visibility of a person in low-light/no-light situations. Most light based systems rely on small low voltage batteries to energize the lights. The reflective material device utilize various mechanisms to efficiently send inbound light directly back in the direction of the light source.

There are also multiple examples of personal lights that are handheld, mounted on headgear or at waist level that utilize a central light source with reflectors and/or lens to create a directional beam of light based on how the person directs the device.

BRIEF SUIMMARY OF THE INVENTION

The present invention comprises a power source, a rear facing series of red lights for viewing by approaching persons or sensors and a flexible curved front facing array of lights that cast a semi-circle of illuminating light to provide enhanced vision to the wearer and to be visible as an alert for approaching persons or sensors. The front facing array incorporates a shield that keeps the light directed to an area parallel to the light array and downward to the surface being used by the wearer. The invention incorporates waterproof components for use with inclement weather conditions.

BRIEF DESCRIPTION OF THE SEVERAL VIEWS OF THE DRAWINGS

All dimensions shown on the drawing are presented in Inches and were determined by measurements of a working prototype device.

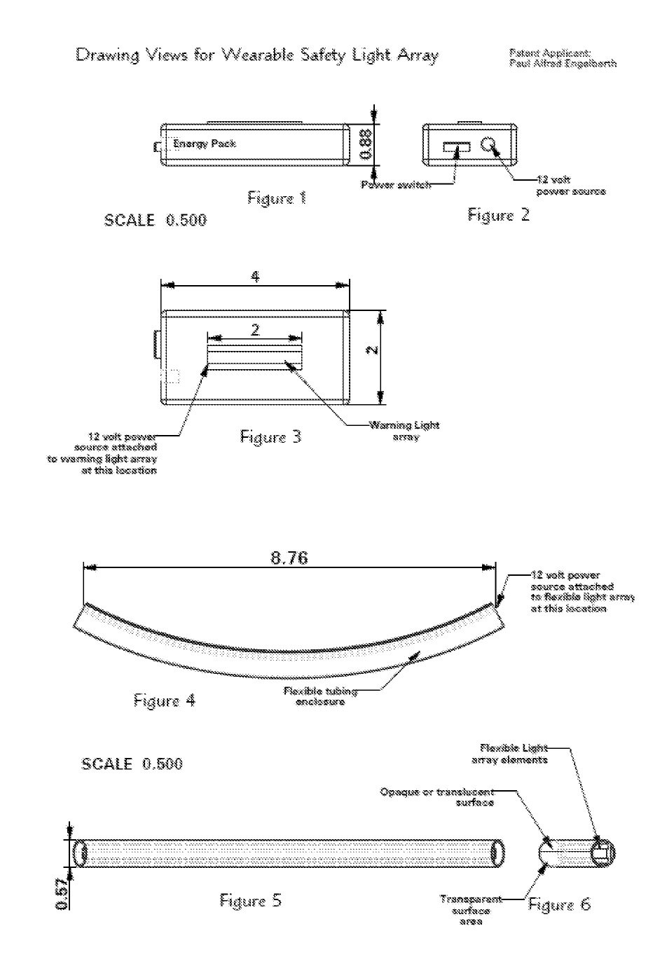

FIG. 1 displays a Top view of the Energy Pack unit.

FIG. 2 shows the Right-side of the Energy Pack that includes the power control on/off switch and the co-axial DC power connection location.

FIG. 3 shows the Front view of the Energy Pack that includes the Rear-facing Safety Light Array that is comprised of multiple red LED light sources.

FIG. 4 shows the Top view of the flexible Front-facing Safety Light Array. The location of the Power Source connection point is indicated with the drawing note.

FIG. 5 displays the Rear view of the flexible Front-facing Safety Light Array.

FIG. 6 presents a Right-side view of the flexible Front-facing Safety Light Array assembly.

FIG. 6 notes identify:

a. the location and coverage of the opaque or translucent light shielding surface;

b. the location and coverage of the transparent portion of the flexible enclosure tube;

c. and the position and orientation of the 12 volt powered flexible LED light array elements.

### DETAILED DESCRIPTION OF THE INVENTION

1. The high energy power source is comprised of a rechargeable Lithium-ion battery pack that provides a 12 volt potential to the light arrays. FIG. 2 identifies the power switch and power source connection location on the Energy Pack. The assembled system includes a 20 gage 2 conductor wire that is connected from the Energy Pack power source directly to the power source attachment point for the Rear-facing Safety Light Array (See FIG. 3) and the power source attachment point for the Front-facing Safety Light Array (See FIG. 4).

2. The Rear-facing Safety Light Array is (See FIG. 3) made up of a one or more strips of waterproof 12 volt red LEDs.

3. The front-facing Safety Light Array has the main elements of:
a. A multi-element LED array strip (See notes on FIG. 6) that projects visible and/or low frequency light outward from the wearer.
b. A waterproof flexible curved enclosure (FIGS. 4, 5, 6) that positions the LED strip into an arc to generate an even pool of light to the front and sides of the wearer.
c. An opaque or translucent area located on the top half and back of curved enclosure (See FIGS. 5 and 6) that directs the generated light forward through a transparent area of the enclosure (See FIG. 6) into a volume that is controlled by the planes defined by the juncture lines between the transparent and non-transparent (opaque or translucent) area on front and bottom sides of the flexible curve enclosure.

### Sequence Listing

Not Applicable

Having described my invention, I claim:

1. A wearable safety light array configured for attachment to the body of a person comprising:
a. a high energy storage device
b. a rear facing safety light array
c. a front facing light array
d. wherein the front facing array is comprised of an array of multiple high output light sources; and
e. mounted within a curved enclosure that directs the light evenly in a semicircle; and
f. wherein the curved enclosure controls direction of the light to be within the space below a mounting plane that is parallel to the ground.

2. A switch connected to the energy storage device to control the flow of energy to the lighting system.

3. A device to allow the rear facing safety light to operate in a mode where it can turn on and off at various rates.

4. A device to allow the front facing light to operate at varying intensities.
